(19) United States
(12) Patent Application Publication
(10) Pub. No.: US 2006/0131415 A1
(43) Pub. Date: Jun. 22, 2006

(54) Device controller for an emulator

(76) Inventor: Darren Scott Irons, Carrollton, TX (US)

Correspondence Address: TEXAS INSTRUMENTS INCORPORATED, P O BOX 655474, M/S 3999, DALLAS, TX, 75265, US

(21) Appl. No.: 11/017,082

(22) Filed: Dec. 20, 2004

(51) Int. Cl. G06K 7/10

(52) U.S. Cl. 235/454

(57) ABSTRACT

A handheld computing device is utilized to control operations of an emulator, which is operating on an emulation system. The handheld computing device may be the device being emulated by the emulator or an electronic device emulating the device being emulated. The handheld computing device is communicatively coupled to the emulation system via a wireless or wired communications link. In an embodiment, the handheld computing device is a calculator coupled to a personal computer running an emulator of the calculator. Input entered on the handheld computing device is sent to the emulator, thereby allowing the user of the handheld computing device to remotely control the operation of the emulator. The personal computer may be coupled to a projector such that a group of students may view the emulator.

### CROSS-REFERENCE TO RELATED APPLICATIONS

This application relates to the following co-pending and commonly assigned patent applications: Ser. No. ______ (Attorney Docket No. TI-39033), filed Dec. 20, 2004, entitled Emulator with Key Press History; and Ser. No. ______ (Attorney Docket No. TI-39036), filed Dec. 20, 2004, entitled Scripting Support for an Emulator, which applications are hereby incorporated herein by reference.

### TECHNICAL FIELD

The present invention relates generally to emulators. In an embodiment it relates more particularly to a device controller for an emulator of a handheld computing device.

### BACKGROUND

Handheld computing devices, e.g., electronic calculators, have become a common tool for teaching students various aspects of mathematics. In particular, the features of graphing calculators are particularly advantageous in a classroom setting to teach students mathematical principles and to illustrate practical applications of concepts taught in class. In fact, many schools now recommend or require students in math classes to use graphing calculators to aid students in learning about advanced math topics, such as trigonometry and calculus.

To aid teachers in a classroom setting, emulators have been developed to emulate the functions and display of the calculator on a computer, such as a desktop computer, a laptop computer, or the like, equipped with a display. Emulators typically comprise a graphical user interface (GUI) that illustrates a graphical representation of the physical calculator. Data is entered and functions are controlled by either clicking on specific keys of the graphical representation or using a keyboard to enter the desired data/commands.

During typical use, a teacher is in front of the computer to control the emulator. The computer running the emulator is coupled to a projector such that the GUI display of the emulator is projected on a screen or other surface, thereby allowing students to watch the teacher illustrate mathematical concepts using the calculator. Another use of an emulator is in conjunction with an electronic whiteboard. This allows the computer to be projected onto the screen and allows the user to “drive” the emulator which is being projected.

This type of use, however, requires that the teacher be located at the computer to enter data and control the emulator. Specifically, the teacher is restricted to a computer as an input device and, therefore, is unable to move around the classroom to provide more individualized instructions to specific students. Hence, there is a need for a way to control the emulator from a remote location such that it allows a teacher to move around the classroom.

### SUMMARY OF THE INVENTION

These and other problems are generally solved or circumvented, and technical advantages are generally achieved, by preferred embodiments of the present invention which provides a device controller for an emulator of a handheld computing device.

In accordance with an embodiment of the present invention, a method for controlling the operation of an emulator is provided. The method comprises entering input on a handheld device. The input is transmitted to an emulation system, such as a personal computer configured to perform an emulator of an electronic device (e.g., a calculator). The input is received by the emulator and the emulator performs the functions corresponding to the input. The input may be digits, commands, functions, or the like. The handheld device may be, for example, a calculator or an electronic device configured to emulate a calculator.

In accordance with another embodiment of the present invention, a handheld device configured to control an emulator executing on an emulation system is provided. The handheld device, such as a calculator or an electronic device configured to emulate a calculator, includes an input device and an output port. The handheld device is configured to receive input via the input device and to transmit the input via the output port. In an embodiment, the handheld device is communicatively coupled to a personal computer executing the emulator via the output port. The input may be digits, commands, functions, or the like.

In accordance with yet another embodiment of the present invention, a computer program for emulating a handheld device is provided. The computer program code accepts input from the handheld device and uses the input to emulate the functions of the handheld device. The input may be digits, commands, functions, or the like.

It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The following is a brief description of the drawings, which illustrate exemplary embodiments of the present invention and in which:

FIG. 1 is a system diagram in accordance with an embodiment of the present invention;

FIG. 2 illustrates an example of a handheld computing device in accordance with an embodiment of the present invention;

FIG. 3 is a block diagram of an emulation system and a handheld computing device in accordance with an embodiment of the present invention; and

FIG. 4 is a data flow diagram illustrating control of the emulation system in accordance with an embodiment of the present invention.

### DETAILED DESCRIPTION OF ILLUSTRATIVE EMBODIMENTS

Referring now to the drawings, wherein like reference numbers are used herein to designate like or similar elements throughout the various views, illustrative embodiments of the present invention are shown and described. The figures are not necessarily drawn to scale, and in some instances the drawings have been exaggerated and/or simplified in places for illustrative purposes only. One of ordinary skill in the art will appreciate the many possible applications and variations of the present invention based on the following illustrative embodiments of the present invention.

Embodiments of the present invention are discussed below with respect to an embodiment utilizing a graphing calculator. It should be noted, however, that embodiments of the present invention may be useful for emulations of any electronic device, particularly handheld computing devices. Examples of other types of handheld computing devices in which embodiments of the present invention may be useful include calculators with a multi-line screen, scientific calculators, advance calculators able to upload and run software applications, handheld-sized limited-purpose computer devices, handheld-sized educational computer devices, handheld-sized portable computer devices having a multi-line screen, portable computer devices having a video screen, personal digital assistants (PDA), palmtop computers, handheld computing devices with a touch screen interface, personal communicators, personal intelligent communicators, cellular or mobile telephones having a multi-line screen, global positioning system (GPS) devices, portable inventory logging computer devices having a multi-line screen (as may be used by courier deliverers, for example), handheld monitoring devices having a multi-line screen (as may be used by meter readers, for example), handheld parking ticket administering devices having a multi-line screen, handheld portable email computer devices having a multi-line screen, handheld portable Internet browsing devices, handheld portable gaming devices, and any combination thereof.

Embodiments of the present invention may be particularly useful in a classroom setting wherein a teacher is utilizing an emulation system to demonstrate mathematical concepts on a calculator, such as a graphing calculator, a scientific calculator, a financial calculator, a programmable calculator, other calculators, or the like. In these embodiments, the handheld computing device may include a calculator or an electronic device configured to emulate a calculator.

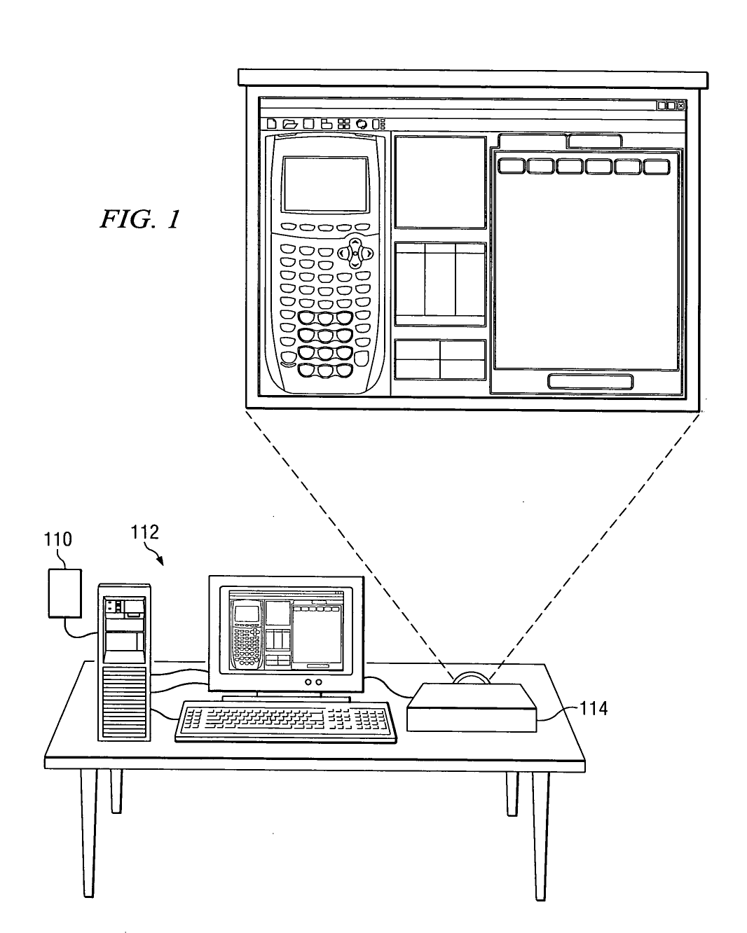

Referring first to FIG. 1, an embodiment of the present invention provides a handheld computing device 110 adapted to communicatively couple to an emulation system 112, which is communicatively coupled to a projector 114. The handheld computing device 110 may be any electronic computing device, such as a calculator, personal data assistant, tablet PC, or the like. For example, in a preferred embodiment the handheld computing device 110 is a graphing calculator such as the TI-84 Plus graphing calculator manufactured by Texas Instruments, Inc., of Dallas, Tex. The TI-84 Plus is a popular graphing calculator used in 6^{th}-12^{th} grades to illustrate various mathematical concepts. In another embodiment, the handheld computing device 110 is an electronic device operating an emulation of another electronic device. For example, the handheld computing device 110 may be a PDA configured to perform an emulation of the TI-84 Plus graphing calculator. Other types of devices may be used.

The emulation system 112 may comprise a general purpose computing device, such as a personal computer, a mini-computer, a main frame, a personal data assistant, a laptop computer, or the like, configured to communicate with the handheld computing device 110 and/or the projector 114.

It should be noted that the communications links between the handheld computing device 110 and the emulation system 112 is illustrated as a wired interface for illustrative purposes only. Accordingly, the handheld computing device 110 and the emulation system 112 may be configured to utilize a wireless communications link, such as a WiFi communications link. In this alternative embodiment, the teacher may achieve an added benefit of an even greater amount of mobility within the classroom.

In operation, as illustrated in FIG. 1, a user (in most cases a teacher) may initiate the emulator on the emulation system 112 during classroom lectures. The emulation system 112 preferably provides a graphical user interface (GUI) comprising a graphical representation of the handheld computing device, e.g., a calculator. The user controls the operation of the emulation in order to illustrate a function of the calculator and/or to illustrate a mathematical concept using either the emulation system 112 or the handheld computing device 110 as an input device. As the user controls the emulator on the emulation system 112, the graphical representation of the calculator is enlarged and displayed on a large surface, such as a screen or wall, via the projector 114. In this manner, the user may use the emulation system 112 to demonstrate the use of the handheld computing device 110 and mathematical concepts. It should be appreciated that when the handheld computing device 110 is utilized to control the emulation system 112, the user is provided greater mobility.

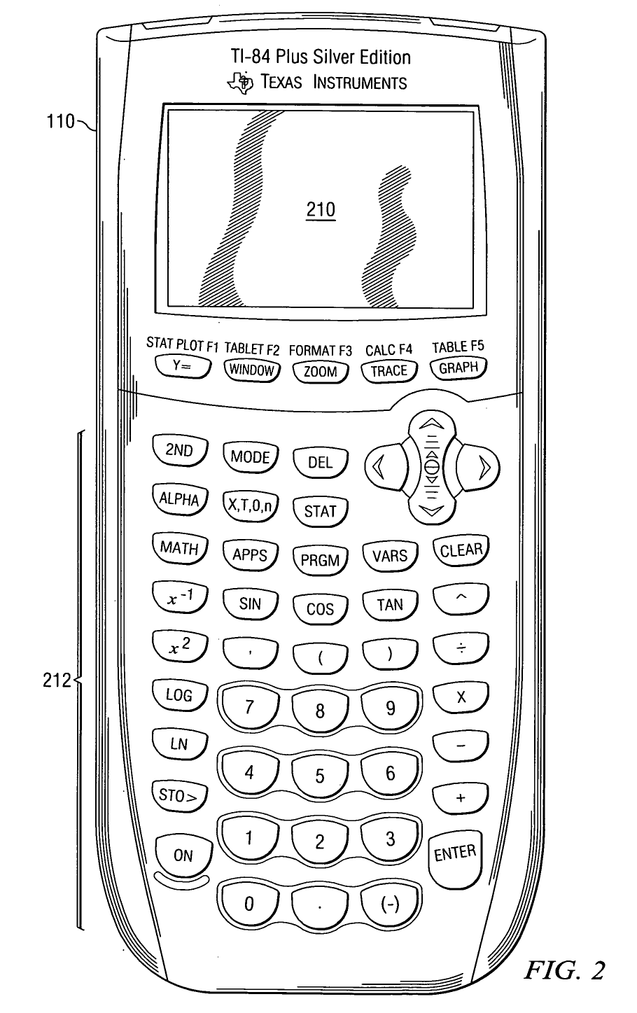

Referring now to FIG. 2, an example of a handheld computing device 110 in accordance with an embodiment of the present invention is shown. For illustrative purposes only, the handheld computing device 110 illustrated in FIG. 2 is similar to a TI-84 Plus graphing calculator. It should be noted that the TI-84 Plus is used for illustrative purposes only and does not limit the invention as claimed.

As shown in FIG. 2, the handheld computing device 110 preferably includes a graphical display 210 and a set of keys 212. The graphical display 210 provides a means upon which graphs of various functions and/or one or more lines of text/symbols may be displayed. The graphical display 210 may be, for example, an LED display. The set of keys 212 is located below the graphical display 210 and provides a method for a user, e.g., a student, to enter data and functions. Other configurations and functions may be used.

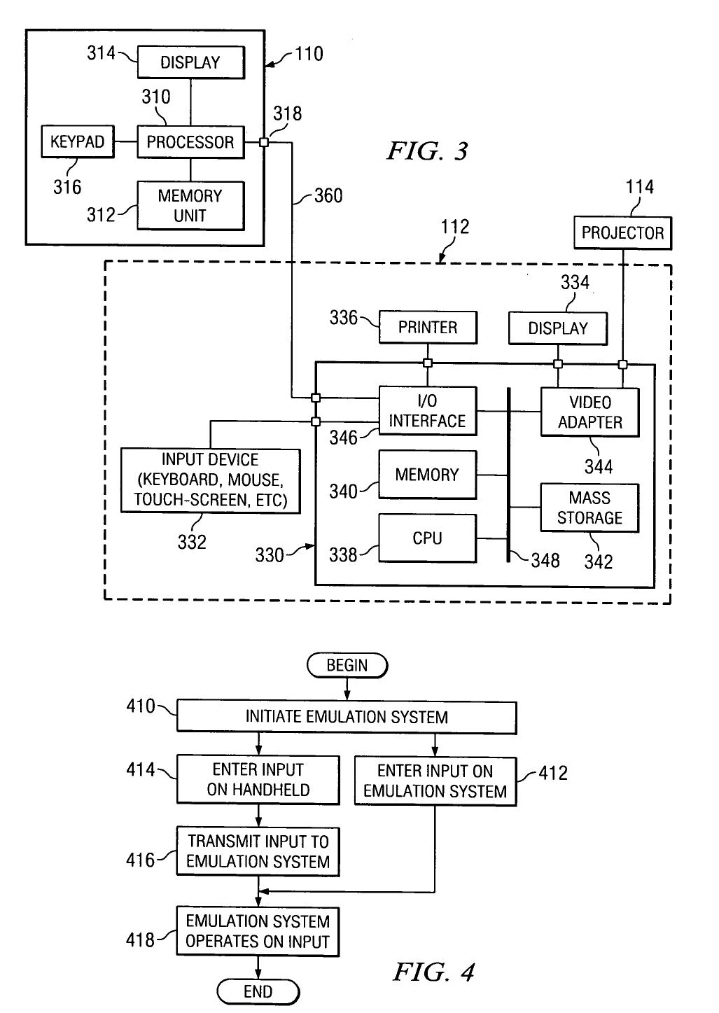

FIG. 3 is a block diagram of the handheld computing device 110 and the emulation system 112 in accordance with an embodiment of the present invention. Generally, the handheld computing device 110 includes a processor 310 connected to a memory unit 312, which may include one or both of read-only memory (ROM) and random-access memory (RAM). In a preferred embodiment, however, the handheld computing device 110 includes ROM to store software programs and RAM to store intermediate data and operating results. Also included in the handheld computing device 110 are a display 314, a keypad 316, and an input/output port 318.

The emulation system 112 may comprise a processing unit 330 equipped with one or more input devices 332 (e.g., a mouse, a keyboard, or the like), and one or more output devices, such as a display 334, a printer 336, or the like. The processing unit 330 may be, for example, a desktop computer, a workstation, a laptop computer, a personal digital assistant, a dedicated unit customized for a particular application, or the like.

Generally, the processing unit 330 includes a central processing unit (CPU) 338, memory 340, a mass storage device 342, a video adapter 344, and an I/O interface 346 connected to a bus 348. The bus 348 may be one or more of any type of several bus architectures including a memory bus or memory controller, a peripheral bus, video bus, or the like. The CPU 338 may comprise any type of electronic data processor. For example, the CPU 338 may comprise a Pentium™ processor from Intel Corp., an Athlon processor from Advanced Micro Devices, Inc., a Reduced Instruction Set Computer (RISC), Application-Specific Integrated Circuit (ASIC), or the like. The memory 340 may comprise any type of system memory such as static random access memory (SRAM), dynamic random access memory (DRAM), synchronous DRAM (SDRAM), read-only memory (ROM), a combination thereof, or the like. In an embodiment, the memory 340 may include ROM for use at boot-up, and DRAM for data storage for use while executing programs.

The mass storage device 342 may comprise any type of storage device configured to store data, programs, and other information and to make the data, programs, and other information accessible via the bus 348. In a preferred embodiment, the mass storage device 342 is configured to store the emulation program to be executed by the CPU 338. The mass storage device 342 may comprise, for example, one or more of a hard disk drive, a magnetic disk drive, an optical disk drive, or the like.

The video adapter 344 and the I/O interface 346 provide interfaces to couple external input and output devices to the processing unit 330. As illustrated in FIG. 3, examples of input and output devices include the display 334 coupled to the video adapter 344 and the mouse/keyboard 332 and the printer 336 coupled to the I/O interface 346. Other devices may be coupled to the processing unit 330.

The processing unit 330 may also include a network interface (not shown) and/or a wireless interface (not shown). The network interface allows the processing unit 330 to communicate with remote units via a network (not shown). In an embodiment, the processing unit 330 is coupled to a local-area network or a wide-area network to provide communications to remote devices, such as other processing units, the Internet, or the like. The network interface may provide an interface for a wired link, such as an Ethernet cable or the like, or a wireless link.

The wireless interface may be provided to allow the processing unit 330 to communicate with other devices via a wireless communications link. As discussed above with reference to FIG. 1, the emulation system 112 may communicate with the handheld computing device 110 via a wireless communications channel.

As illustrated in FIG. 3, the handheld computing device 110 is communicatively coupled to the emulation system 112 via communications link 360, which may be a wireless or a wired communications link. In a preferred embodiment, the I/O port 318 is a mini-B USB port incorporated in the handheld computing device 110. In this embodiment, the communications link 360 is a USB cable coupled to a standard-A USB connection of the emulation system 112. The length and weight of the communications link 360 should be such that the user of the handheld device is able to move freely about the classroom.

It should be noted that the emulation system 112 and the handheld computing device 110 may include other components. For example, the emulation system 112 and the handheld computing device 110 may include power supplies, cables, a motherboard, removable storage media, cases, and the like. These other components, although not shown, are considered part of the emulation system 112 and the handheld computing device 110.

It should also be noted that all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise. In other embodiments, a hardware system may be specifically designed to perform one or more of the functions described herein.

FIG. 4 is a flow chart illustrating the operation of an embodiment of the present invention. The processing begins in step 410, wherein the emulation system 112 (FIG. 1) is initiated. Initiating the emulation system 112 may include installing and executing an emulation program on the emulation system 112, e.g., a laptop computer, attaching a projector or other display to the emulation system 112, and configuring a communications link between the handheld computing device 110 and the emulation system.

Referring back to FIG. 4, the branch in processing after step 410 illustrates that an input sequence may be entered on either the emulation system 112 (step 412) or the handheld computing device 110 (step 414). The input sequence may include, for example, keystrokes, mouseclicks, button positions, switch positions, or combinations thereof and may represent, for example, a series of digits, commands (e.g., store, recall, graph, list, print, etc.), or functions (e.g., x², x³, compute, tan, sin, cos, etc.). By allowing a user to couple the handheld computing device 110 to the emulation system 112 and to enter an input sequence on the handheld computing device 110, it allows the user greater mobility. This greater mobility is particularly useful in a classroom setting in which the user, e.g., the teacher, is attempting to teach specific concepts to a group of students. The mobility allows the teacher to move around the classroom, going from student to student easily while maintaining control of the emulator.

After entering an input sequence on the handheld computing device 110 in step 414, the process proceeds to step 416, wherein the input sequence that was entered on the handheld computing device 414 is transmitted to the emulation system 112. In a preferred embodiment, the data transmitted to the emulation system 112 comprises a sequence of individual input elements entered on the handheld computing device 110, as opposed to a graphical representation of the keystrokes. Furthermore, it is also preferred that the input sequence is transmitted as entered, without performing a pre-processing function on the sequence of keystrokes.

Thereafter, in step 418, the emulation system 112 operates on the input sequence entered on the handheld computing device 110 and/or an input device connected to the emulation system 112. In this manner, the handheld computing device 110 may act as an input device to the emulation system 112. Operating on the input sequence may include, for example, displaying a graphical representation of the input sequence or performing the functions/commands associated with a keystroke.

In a preferred embodiment in which the emulation system 112 includes a graphical representation of the emulated device (e.g., a calculator), the emulation system 112 indicates the each individual element of the input sequence entered by either the handheld computing device 110 or another input device communicatively coupled to the emulation system 112 on the graphical representation presented on the display. For example, keystrokes entered on the handheld computing device may be indicated by bolding, color changes, 3-D effects, shading, or the like. By indicating the entered keystrokes, the student is able to readily view the process and keystrokes the teacher is utilizing to solve a problem or illustrate a mathematical concept.

It is further preferred that a key press history of the keystrokes entered by the handheld computing device 110 or an input device communicatively coupled to the emulation system 112 are illustrated. The use of a key press history is discussed further in co-pending U.S. patent application Ser. No. ______ (Attorney Docket No. TI-39033), which is incorporated herein by reference.

It should also be noted that the display of the handheld computing device 110 may or may not be activated when used in conjunction with an emulation system 112 as described above. However, it is preferred that the display of the handheld computing device 110 be activated to allow the user to witness the results of the keystrokes without looking at the display coupled to the emulation system. In this embodiment, it is preferred to allow both the handheld computing device 110 and the emulation system 112 to each individually determine the correct response to the keystroke(s) entered by the user. The handheld computing device 110 preferably only transmits the keystrokes entered on the handheld computing device 110 to the emulation system 112, not the results. In other embodiments, however, other data, such as scripts, results, or the like, may be passed between the handheld computing device 110 and the emulation system 112.

While embodiments of the present invention have been described above with respect to an embodiment in which the handheld computing device is a graphing calculator, embodiments of the present invention may be used to illustrate the use of other handheld devices. For example, an embodiment of the present invention may be utilized to illustrate the use of a PDA (or other handheld computing device) to a group of students. In this embodiment, the PDA may be communicatively coupled to an emulation system on which an emulation of the PDA may be executing. An instructor may control the emulation system by using the PDA being emulated as an input device, wherein the PDA transmits the sequence of keystrokes or commands entered on the PDA to the emulation system.

Although embodiments of the present invention and at least some of its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An emulation system comprising:
a first processor configured to perform mathematical operations, the mathematical operations corresponding to mathematical operations available on a handheld computing device;
a graphics memory communicatively coupled to the first processor, the graphics memory being configured for storing display information;
an input port communicatively coupled to the first processor; and
memory communicatively coupled to the first processor, the memory being configured to store computer program code to cause the first processor to perform an emulator of the handheld computing device, the emulator being configured to accept an input sequence from the handheld computing device communicatively coupled to the input port.

2. The emulation system of claim 1, further comprising a projector for displaying output from the emulator on a surface.

3. The emulation system of claim 1, wherein the handheld computing device comprises a calculator.

4. The emulation system of claim 1, wherein the handheld computing device comprises a first electronic device configured to emulate a second electronic device.

5. The emulation system of claim 4, wherein the second electronic device comprises a calculator.

6. The emulation system of claim 1, wherein the input sequence received from the handheld computing device comprises keystrokes, mouse clicks, button positions, switch positions, or combinations thereof entered on the handheld computing device.

7. The emulation system of claim 1, further comprising a first display communicatively coupled to the graphics memory, wherein the computer program code is configured to cause the input sequence to be displayed on the first display.

8. The emulation system of claim 1, wherein the handheld computing device comprises:
a second processor configured for performing mathematical operations;
a display communicatively coupled to the second processor;
an input device communicatively coupled to the second processor; and
an output port configured to communicatively couple the handheld computing device to the input port, wherein the handheld computing device is configured to output on the output port the input sequence entered on the input device.

9. The emulation system of claim 8, wherein the output port comprises a USB port.

10. The emulation system of claim 1, wherein the input sequence is a one-for-one representation of input entered on the handheld computing device.

11. A method of instruction of students in a classroom, the method comprising:
communicatively coupling a calculator to an emulation system, the emulation system being configured to emulate the calculator;
displaying an output of the emulation system to a plurality of students;
receiving by the emulation system an input sequence from the calculator; and
emulating by the emulation system behavior of the calculator in accordance with the input sequence.

12. The method of claim 11, wherein the calculator comprises an electronic device configured to emulate the calculator.

13. The method of claim 11, wherein the calculator is a graphing calculator.

14. The method of claim 11, wherein the students are in a grade level from sixth grade to twelfth grade.

15. The method of claim 11, wherein the emulation system comprises a personal computer performing an emulator of the calculator.

16. A computer program product for emulating a first handheld device, the computer program product having a medium with a computer program embodied thereon, the computer program comprising:
computer program code for receiving an input sequence from the first handheld device, the input sequence representing input to the first handheld device; and
computer program code for emulating the first handheld device in accordance with the input sequence.

17. The computer program product of claim 16, wherein the first handheld device is a calculator.

18. The computer program product of claim 16, wherein the first handheld device is an electronic device configured to emulate a calculator.

19. The computer program product of claim 16, further comprising computer program code for indicating on a display keystrokes entered on the first handheld device.
